(19) United States
(12) Patent Application Publication
(10) Pub. No.: US 2010/0018769 A1
(43) Pub. Date: Jan. 28, 2010

(54) Method and apparatus for allowing future installation of wires, cables, fibers, and the like into a structure

(76) Inventor: Mike L. Massey, Midland, TX (US)

Correspondence Address: LAW OFFICES OF CHRISTOPHER L. MAKAY, 1634 Milam Building, 115 East Travis Street, San Antonio, TX, 78205, US

(21) Appl. No.: 12/220,383

(22) Filed: Jul. 24, 2008

(51) Int. Cl. H02G 15/04

(52) U.S. Cl. 174/77 R

(57) ABSTRACT

A method and apparatus is provided that allows for the running of wires, cables, fibers or the like from the outside of a structure to its interior after construction is completed. The method and apparatus includes a conduit installed during the construction of the structure. The conduit contains insulating material and is sealed to prevent heat or cool air from escaping the structure. The conduit is installed onto an interior support surface and protrudes outward, with the exterior wall of the structure built around it. At such time when the addition of wire, cable, fibers or the like is desired, the conduit is unsealed, the insulating material removed, wires cables, fibers or the like are run from the outside of the structure to the inside, the insulation is replaced and the conduit is resealed.

### BACKGROUND OF THE INVENTION

1. Field of the Invention

The present invention relates to a method and apparatus for allowing the future installation of wires, cables, fibers or the like, from the outside of a completed structure through an exterior wall.

2. Description of the Related Art

During the construction phase of commercial and residential structures, in addition to basic electrical wiring, builders must install wires, cables, fiber and other transmission means for the purpose of sending data or signals, such as cable television, satellite television, telephone, internet or video surveillance feeds throughout the building. In most of these examples, the sources for these data or signals originate from outside the structure, such as a satellite dish or a telephone network interface box. A method of penetrating an exterior wall is provided for during the construction of the building to allow the wires, cables, and fibers to enter the structure. An example would be a satellite television dish mounted on the roof of house. Multiple coaxial cables would have to travel down the side of the house to an entry point on an exterior wall. The cables would then enter the house at a designated point, where they would run through the walls of the house to different wall jacks where the signal could be transmitted to satellite receivers connected to television sets in different rooms.

As technology changes and upgrades occur, there is often a need to install additional wire, cable, fiber and the like. For example, a home built in the 1980's may have been pre-wired for cable television using older coaxial cable. If a resident wishes to upgrade to high-definition satellite television, the older coaxial cable may be incapable of handling the increased bandwidth and must therefore be replaced. In addition, the location of where a satellite dish must be placed in order to achieve optimum reception may not be close to the existing penetration point.

In the construction of many buildings, provisions are not made for the installation of additional wires, cables and fiber. In those construction projects where builders do anticipate this need, limited methods exist to allow for this. In most situations, waterproof outlet boxes are installed either inside the wall cavity or on the surface of the exterior wall. Conventional conduit and elbow fittings are then used to run the wires, cables or fibers from outside the building to an access point inside the building.

If there are no provisions made for the future installation of wires, cables or fibers, several problems arise when a homeowner or business owner decides that upgrading or adding additional wires, cables or fibers is necessary.

Typically, an installer will run conduit to house the wires, cables and fibers externally on the exterior of the structure. This is aesthetically unpleasing and can lower curb appeal and property values.

In addition, if the entry point into the structure is far from the signal source, a run can be quite long, which requires extensive labor and a large amount of conduit to house the wires, cables or fibers, which can be costly. For example, a satellite dish may need to be mounted on the top of a multistory house where the mounting point is on the west side of the home in order to achieve an unobstructed view of the southern sky for receiving the satellite transmission. The entry point may be on the opposite side of the house and on the lower floor. This can result in a long run of expensive conduit that goes across the entire length of the house and then two stories down, in addition to requiring a large amount of labor to install.

Another method of adding wires, cables or fibers to a structure that does not provide for future installation is to simply drill holes into an exterior wall with exposed wire or cable draped outside of the structure. In addition to being unsightly and unaesthetic, it may be a violation of the local building code of that jurisdiction.

In situations where provisions are made for the future addition of wires, cables and fibers, typically as described earlier where waterproof outlet boxes, conduit and elbow fittings are used, these can be problematic in that they create a breach in the wall insulation. This can increase the cost of heating and cooling a building because of air leakage through these breaches. This can result in higher energy costs as well as increasing the effect on the environment from the use of more energy to make up for these leakages, such as atmospheric ozone depletion and buildup of greenhouse gases.

Also, any situation where holes must be drilled into an existing exterior surface is detrimental to the structure. These holes can weaken the area surrounding them. In addition, even when these holes are sealed, sealants can break down due to age or settlement of the structure, creating breaches in which insects, vermin or moisture can penetrate.

Accordingly, a preinstalled, insulated conduit that penetrates the exterior wall of structure into the inner cavities of the structure that preserves the integrity of the structure and prevents heating and cooling loss would be significantly advantageous.

### SUMMARY OF THE INVENTION

In accordance with the present invention, a method and apparatus allows for the future installation or addition of wire, cables, fiber and the like into a structure from outside the structure through a preinstalled, insulated conduit.

Wire, cables, fibers and the like may be any type of transmission means that can carry a signal, electrical current, or the like from one point to another.

The conduit described can be any size or shape capable of enclosing or partially enclosing wires, cables, fibers or the like. In the preferred embodiment, the conduit is a milled single piece tube that is made of plastic, polyvinyl chloride (PVC), polyethylene or the like. The exterior facing section of the conduit is a hollow cylinder, with the interior facing section of the conduit being a continuous concave wall extending past the cylinder section to create a mounting surface. An insulating plug made from a lightweight expandable foam, fiber or the like is inserted into the cylindrical portion of the conduit and held into place by compression friction, adhesive or the like until the wire, cable or fiber is to be installed. An end cap is placed over the open end of the conduit to seal it and protect the insulating plug.

The conduit is installed during the construction of the structure, typically during the framing phase and prior to the attachment of the sheetrock, interior finish, exterior sheathing and the exterior surface of the structure. The conduit is attached to an interior support surface, such as a common two by four, by a fastener. The fastener may a bracket, nail, screw, staple, adhesive or the like. In the preferred embodiment, the fastener would be a nail or screw extending into an opening within a mounting surface of the conduit. The mounting surface portion of the conduit contains a set of openings on opposing ends of the surface to allow for insertion of an attachment means, such as nails or screws. By using either set of openings on one of the opposing ends, the open part of the conduit can face in the direction desired for the wire, cables or fiber to travel after exiting the conduit. Typically, the positioning of the conduit's open end would be to face the opening of another conduit to allow for the other conduit to receive the wire, cable or fiber, from the opening of this conduit.

The conduit would penetrate and extend past the exterior sheathing a sufficient distance to allow for an exterior surface of the structure, such as brick, stucco or the like, to be built around the conduit. The distance the conduit extends past the exterior sheathing is approximately 8 inches, but could vary depending on the thickness of the exterior surface. Once the exterior surface of the structure is completed, the end cap would be removed, the insulating plug removed, and the conduit's length would be cut down to achieve about a 2 inch protrusion from the exterior surface, although this amount may vary depending upon the situation. The insulating plug would then be cut down to fit into the conduit and replaced back into the conduit. The end cap would be reinstalled and the conduit sealed.

The conduit would remain in this state until such time as additional wires, cables, fibers or the like needed to be run from the outside of the structure to the inside. To add additional wire, cable, fiber or the like, the end cap would be removed from the conduit and the insulating plug removed. A small hole or holes would be drilled into the bottom of the conduit where it protrudes from the exterior wall of the structure to achieve a water resistant entry for the wires, cables or fibers to enter the conduit. The wires, cables or fibers would be pulled though the conduit and into the interior of the structure where they would exit the conduit from the opening created by the mounting surface portion of the conduit. The insulating plug would be compressed to accommodate the additional wire, cables or fiber and the end cap replaced.

It is therefore an object of the present invention to provide a one piece, inexpensive conduit that can be preinstalled into a structure to allow for the future installation of wires, cables and fibers from the outside of the structure into the interior.

It is a further object of the present invention to provide a preinstalled conduit that is insulated to prevent heated or cooled air from escaping from the structure.

It is a further object of the present invention to provide a preinstalled conduit with a mounting surface that can be attached to allow for the interior opening of the conduit to face the direction that the installer wishes to run the wires, cables and fibers.

It is still a further object of the present invention to provide a method of pre-installing a conduit into a structure to allow for the future installation of wires, cables and fibers from outside of the structure into the interior.

Still other objects, features, and advantages of the present invention will become evident to those of ordinary skill in the art in light of the following,

### BRIEF DESCRIPTIONS OF THE DRAWINGS

FIG. 1 is a side, slightly elevated perspective view of the conduit prior to installation.

FIG. 2 is top view of the conduit prior to installation.

FIG. 3 is top cross-sectional view of the conduit, without the insulating plug installed or the end cap attached.

FIG. 4 is a side view of the end cap and insulating plug removed from the conduit.

FIG. 5 is a top cross-sectional view of the conduit, with the insulating plug installed and the end cap attached.

FIG. 6 is an end view of the conduit attached to an interior support surface using an attachment means, with the interior opening facing downward.

FIG. 7 is a side view of the conduit attached to an interior support surface and penetrating the exterior sheathing, prior to the construction of the exterior surface.

FIG. 8 is a side view of the conduit attached to an interior support surface, penetrating the exterior sheathing, extending past the exterior surface with the wires, fibers or cables installed.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps. While the preferred embodiment has been described, the details may be changed without departing from the invention, which is defined by the claims.

Like referenced characters are used throughout this description to identify like parts.

The present invention relates to a method and apparatus for allowing the future installation or addition of wire, cables, fiber and the like into a structure from outside the structure though a preinstalled, insulated conduit.

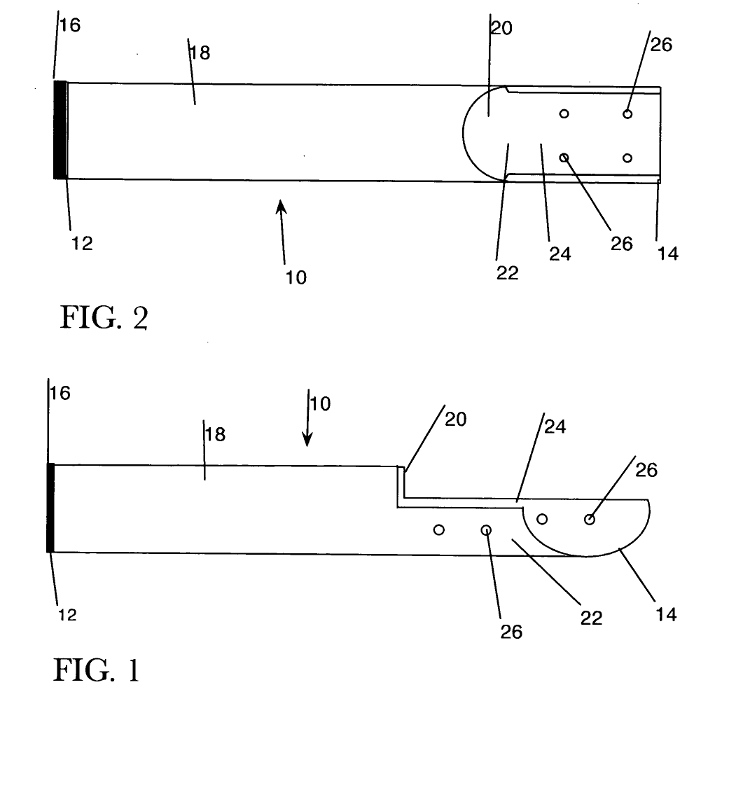

In FIGS. 1 and 2, a conduit 10, with a first end 12 and a second end 14 is shown. At the first end 12 is an opening 16 of a substantially cylindrical tube section 18 that extends along a longitudinal axis. The tube section 18 terminates at an opening 20. At the opening 20, a mounting surface 22 projects axially as a continuous concave wall from the tube section 18. The mounting surface 22 terminates at the second end 14, forming an opening 24 perpendicular to the opening 16. Disposed within the mounting surface 22 at opposing ends are sets of mounting holes 26.

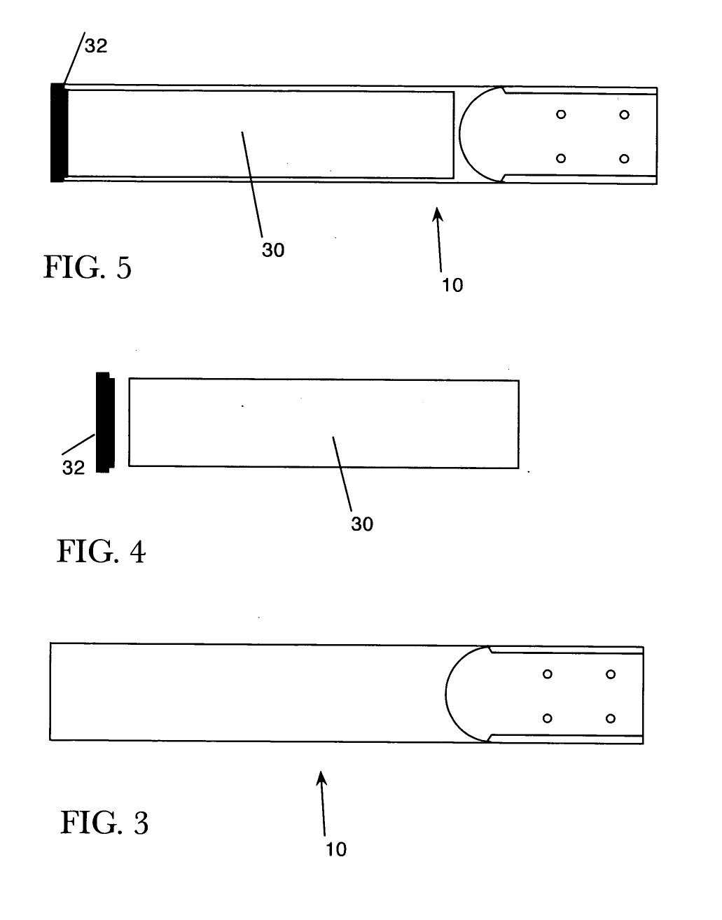

In FIGS. 3 and 4, the conduit 10, an insulating plug 30 and an end cap 32, with the end cap 32 and the insulating plug 30 removed are shown.

In FIG. 5, the conduit 10 is shown with the insulating plug 30 compressed and inserted within the tube section 18. The end cap 32 is inserted into the opening 16 to seal the insulating plug within the conduit 10.

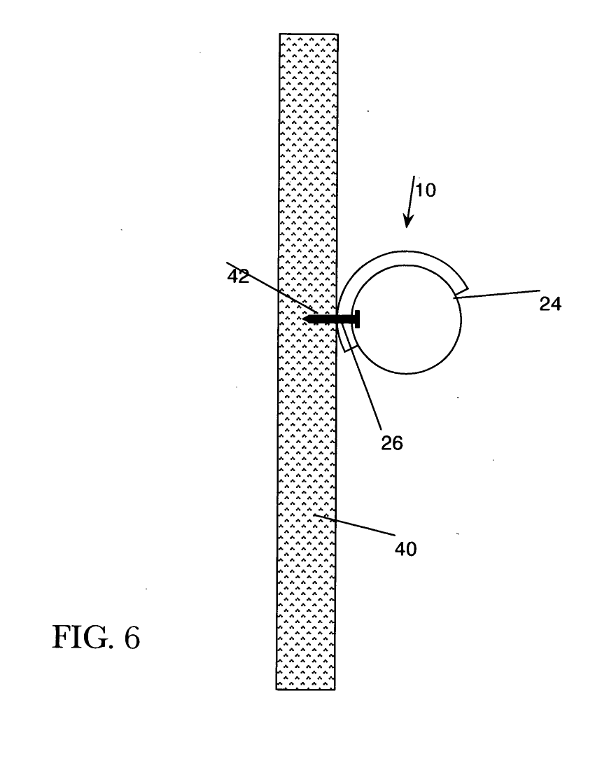

In FIG. 6, the conduit 10 is shown installed onto an interior support surface 40. The conduit 10 is placed onto an interior support surface 40 and mounting screws 42 are driven through the appropriate set of the mounting holes 26 such that the opening 24 is situated in the desired direction.

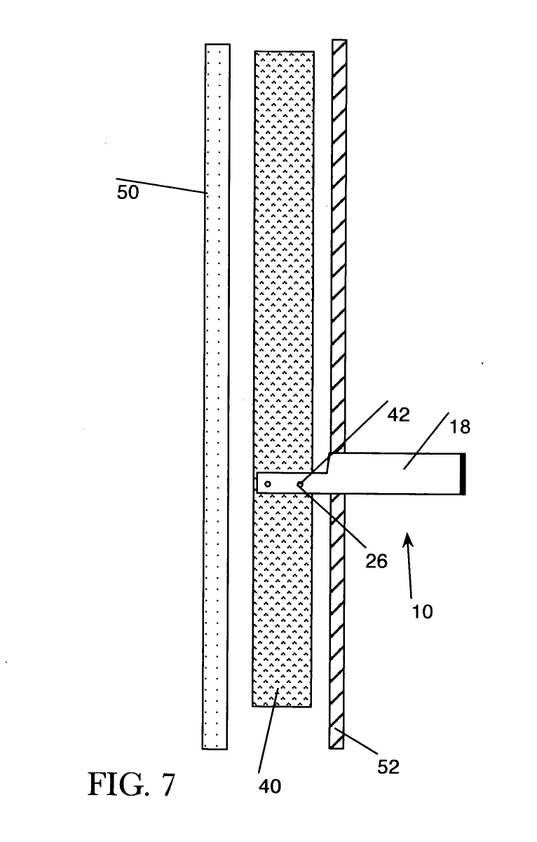

In FIG. 7, the conduit 10 is shown installed in place prior to the construction of an exterior wall. The conduit 10 is disposed through an exterior sheathing 52 of the structure. The conduit 10 is placed onto the interior support surface 40 disposed between a sheetrock section 50 and the exterior sheathing 52. The mounting screws 42 are driven through the appropriate set of the mounting holes 26 such that the opening 24 is situated in the desired direction. The tube section 18 extends outward from the exterior sheathing 52 to allow for the conduit 10 to extend past the exterior surface.

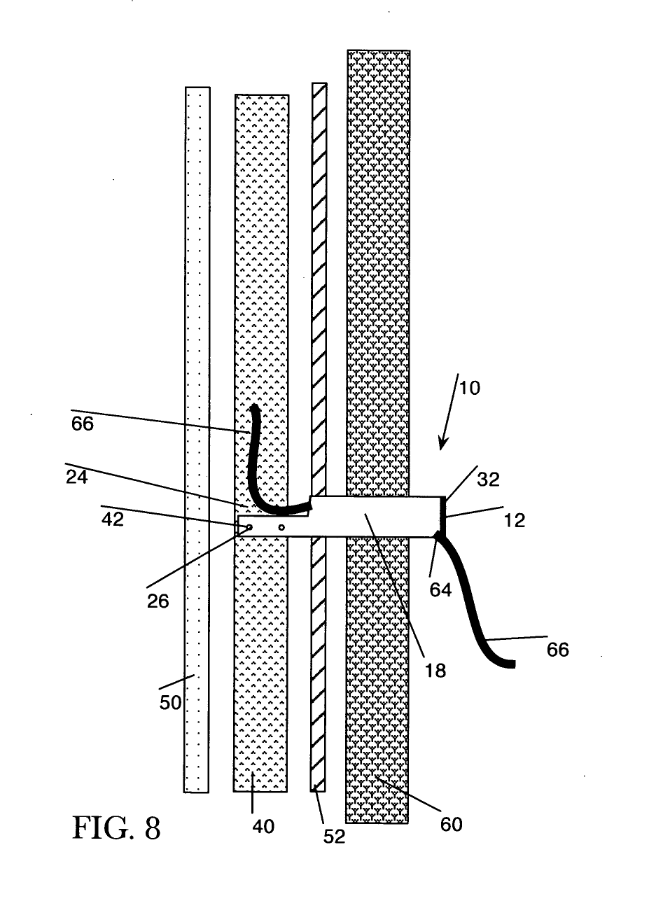

In FIG. 8, the conduit 10 is shown installed in place after the construction of an exterior wall and installation of a cable 66. The conduit 10 is disposed through the exterior sheathing 52 of the structure. The conduit 10 is placed onto the interior support surface 40 disposed between the sheetrock section 50 and the exterior sheathing 52. The mounting screws 42 are driven through the appropriate set of the mounting holes 26 such that the opening 24 is situated in the desired direction. The tube section 18 extends outward from the exterior sheathing 52 to allow for the conduit 10 to protrude from any exterior surface. An exterior wall 60 is built around the conduit 10. The end cap 32 is removed and the insulating plug 30 (not shown) is extracted from the tube section 18. The conduit 10 is cut back from first end 12 to allow for adequate protrusion and access from the exterior wall 60. The insulating plug 30 (not shown) is shortened to fit into the resized tube section 18. The insulating plug 30 (not shown) is compressed, placed back into the tube section 18 and the end cap 32 is inserted back into the opening 16.

At the desired time, the end cap 32 is removed from the opening 16 and the insulating plug 30 (not shown) is extracted from the tube section 18. An entry point 64 is drilled into the bottom of the tube section 18 and a wire 66 is inserted into the entry point 64 and drawn through the conduit 10, exiting at the opening 24. When the desired length of the wire 66 is drawn through into the interior of the structure, the insulation plug 30 is compressed and replaced into the tube section 18 of the conduit 10. The end cap 32 is replaced, sealing the conduit 10.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Although the present invention has been described in terms of the foregoing preferred embodiments, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. An apparatus for allowing the future installation of wires, cables, fibers, and the like into a structure, comprising:
a conduit including a first end and a second end;
at least one fastener adapted to secure the conduit to a structure such that the first end of the conduit is disposed interior to the structure and the second end of the conduit protrudes from the structure.

2. The apparatus for allowing the future installation of wires, cables, fibers, and the like into a structure according to claim 1, further comprising a seal adapted to cover the second end.

3. The apparatus for allowing the future installation of wires, cables, fibers, and the like into a structure according to claim 2, further comprising an insulator adapted to fit within the conduit.

4. The apparatus for allowing the future installation of wires, cables, fibers, and the like into a structure according to claim 1, wherein the opening at the first end opens into a generally tubular hollow section, and a wall projects from the tubular hollow section and terminates at the first end.

5. The apparatus for allowing the future installation of wires, cables, fibers, and the like into a structure according to claim 4, wherein the wall projecting from the tubular hollow section is concave in shape and forms an opening at the second end which is generally perpendicular to the opening at the first end.

6. The apparatus for allowing the future installation of wires, cables, fibers, and the like into a structure according to claim 5, wherein the at least one fastener is disposed within the wall projecting from the tubular hollow section for attachment of the conduit to the interior of the structure.

7. The apparatus for allowing the future installation of wires, cables, fibers, and the like into a structure according to claim 6, wherein at least one attachment hole is disposed within the wall projecting from the tubular hollow section for receiving therein the at least one fastener.

8. The apparatus for allowing the future installation of wires, cables, fibers, and the like into a structure according to claim 7, wherein the at least one fastener is a nail, screw, staple, bracket, or adhesive.

9. The apparatus for allowing the future installation of wires, cables, fibers, and the like into a structure according to claim 6, wherein at least a first attachment hole is disposed at one edge of the concave wall and at least a second attachment hole is disposed within the opposing edge of the concave wall to allow for the opening at the second end of the conduit to be positioned in a desired direction.

10. A method of installing a conduit that allows for the future installation of wires, cables, fibers, and the like into a structure, comprising:
constructing an interior portion of a structure;
securing the conduit to the interior portion of the structure; and
constructing an exterior portion of the structure such that a first end of the conduit is disposed interior to the structure and a second end of the conduit protrudes exterior to the structure.

11. The method of installing a conduit that allows for the future installation of wires, cables, fibers, and the like into a structure according to claim 10, further comprising:
inserting an insulating plug into the conduit; and
placing an end cap over the conduit at the second end.

12. The method of installing a conduit that allows for the future installation of wires, cables, fibers, and the like into a structure according to claim 11, further comprising:
creating an opening in the conduit; and
inserting a wire, cable, fiber, and the like into the conduit through the opening and into the structure through the first end of the conduit.

13. The method of installing a conduit that allows for the future installation of wires, cables, fibers, and the like into a structure according to claim 11, further comprising:
removing the end cap from the conduit;
removing the insulating plug from the conduit;
creating an opening in the conduit;
inserting a wire, cable, fiber, and the like into the conduit through the opening and into the structure through the first end of the conduit;
replacing the insulating plug into the conduit; and
replacing the end cap over the conduit.

14. The method of installing a conduit that allows for the future installation of wires, cables, fibers, and the like into a structure according to claim 11, further comprising:
removing the end cap from the conduit;
removing the insulating plug from the conduit;
creating an opening in through the insulating plug and end cap;
inserting a wire, cable, fiber, and the like through the openings in the insulating plug and end cap, into the conduit through the second end thereof, and into the structure through the first end thereof;
replacing the insulating plug into the conduit; and
replacing the end cap over the conduit.

15. The method of installing a conduit that allows for the future installation of wires, cables, fibers, and the like into a structure according to claim 10, further comprising:
trimming the conduit at the second end to a desired length;
inserting an insulating plug into the conduit; and
placing an end cap over the conduit at the second end.

16. The method of installing a conduit that allows for the future installation of wires, cables, fibers, and the like into a structure according to claim 15, further comprising:
creating an opening in the conduit; and
inserting a wire, cable, fiber, and the like into the conduit through the opening and into the structure through the first end of the conduit.

17. The method of installing a conduit that allows for the future installation of wires, cables, fibers, and the like into a structure according to claim 15, further comprising:
removing the end cap from the conduit;
removing the insulating plug from the conduit;
creating an opening in the conduit;
inserting a wire, cable, fiber, and the like into the conduit through the opening and into the structure through the first end of the conduit;
replacing the insulating plug into the conduit; and
replacing the end cap over the conduit.

18. The method of installing a conduit that allows for the future installation of wires, cables, fibers, and the like into a structure according to claim 15, further comprising:
removing the end cap from the conduit;
removing the insulating plug from the conduit;
creating an opening in through the insulating plug and end cap;
inserting a wire, cable, fiber, and the like through the openings in the insulating plug and end cap, into the conduit through the second end thereof, and into the structure through the first end thereof;
replacing the insulating plug into the conduit; and
replacing the end cap over the conduit.
